(19) United States
(12) Patent Application Publication
(10) Pub. No.: US 2007/0140663 A1
(43) Pub. Date: Jun. 21, 2007

(54) Multi-programme recording in dvd compliant format

(75) Inventors: Alexis S.R. Ashley, Redhill (GB); Octavius J. Morris, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/558,488

(22) PCT Filed: May 21, 2004
(86) PCT No.: PCT/IB04/01768

§ 371 Date: Nov. 28, 2005

(30) Foreign Application Priority Data
May 31, 2003 (GB) 0312518.4

(51) Int. Cl. H04N 7/26

(52) U.S. Cl. 386/112

(57) ABSTRACT

There is a desire to simultaneously record two or more programmes (sources 28). There is hereby disclosed a method of and apparatus for recording two or more independent video programmes simultaneously to a recordable DVD (digital versatile disk) (10) while maintaining conformance to the DVD Video specification. The DVD Video specification does not permit gaps between recorded programmes. The novel apparatus uses the multi-angle feature of DVD Video for multiplexing received data streams representing the A/V programmes from different tuners or a television multiplex into one digital video data stream (30) and recording the stream to the recording medium (10). The DVD table of contents is written so that when played back on a digital video player, the two viewing angles appear as separate programmes, and the user's ability to change angle can be disabled automatically to conceal the manner of recording.

The present invention relates to simultaneous recording of AV streams to optical media, and in particular to simultaneous recording of two or more programmes to a DVD (digital versatile disk) Video compliant disk while maintaining conformance to the DVD Video specification.

The DVD Video specification was designed as an extension of the DVD format itself for the distribution of pre-recorded materials such as films. At a very simplified level, video must start at the beginning of the disk and run continuously until the end. Video recording products such as the DVD+RW recorder, which aim to maintain conformance to the DVD Video specification, must start at the beginning of the disk and append each recorded programme one after the other.

Because the DVD Video specification requires there to be no gaps between recordings, a problem arises when a device has two tuners (or two programmes from one digital television multiplex) and the need arises to record two programmes simultaneously. The need to record two (or more) programmes on a disk simultaneously could in theory be met by recording each programme starting at a separate part of the disk. However the recorder cannot start recording one programme on one part of the disk and start recording the other somewhere else on the disk because it has no way of knowing exactly how long each recording will be. Therefore a gap would be insurable.

Another problem with this approach to simultaneous video recording is that the it requires moving the disk head repeatedly back and forth between the two recordings. This is undesirable due to the noise created and because of the inevitable wear and tear caused which would shorten the life of the unit.

It is known from EP 1152612 to record two simultaneous video broadcasts on a tape (or other medium) as a single multiplexed stream, but this is to allow simultaneous recording of digital and analogue broadcast signals of the same programme, and does not address the particular problems which arise with simultaneous recording due to the DVD video specification.

It is an object of the present invention to address the aforementioned problems encountered when attempting to record two or more programmes simultaneously while marinating DVD Video specification compliance.

In a first aspect of the invention there is provided a method of recording two or more independent video programmes simultaneously to a digital video recording medium, in a manner compliant with a standard format, the method comprising using a multi-angle feature of the standard format for multiplexing small sections of each programme into one digital video stream and recording the multiplexed video stream to said medium.

The standard format may be DVD Video format, for which many players and pre-recorded disks are already installed. In that case the multiplexed video streams will be in MPEG2 format (CCITT H.222). Needless to say, the invention is adaptable to any other format having a multi-angle feature, including any future format that may emerge as a successor to DVD Video.

DVD players commonly have a multi-angle feature which allows a programme to be recorded on a disk from a number of different angles (usually up to 9) so that, for instance, a DVD of a football match can be watched by the viewer from a preferred camera angle. DVD recorders also commonly have this feature so that if, for example, one is recording a digital sport broadcast from an interactive provider having a multi-angle feature, the recorded programme retains the multi-angle feature each may have its own audio track according to the standards. The invention exploits this existing facility to separate broadcast programmes simultaneously.

When the multiplexed section is played back, a DVD player will play the section of that original stream being played, and automatically skip past the sections of the other streams to the next section containing video for this stream and so on, just as if it was playing a multi angle section of video.

In the exemplary embodiment of the invention each video stream is an A/V stream also containing audio information.

The method may further comprise recording a table of contents for the medium, in which the different angles appear as separate entries.

The method may further comprise recording control information such that, during playback of the multiplexed section, the user's ability to change angle is disabled.

Each original stream may be a different programme sourced from different tuners or alternatively the programmes may be sourced from one digital television multiplex (such as MPEG2 Transport Stream format) each programme having a different programme ID within that format.

When, in the course of recording all but one stream ends, the remaining stream may be recorded as a normal stream, with no multi-angle features.

The term “programme” is used herein with the everyday meaning attributed to it by TV viewers. In the case where video streams are received from an MPEG2 Transport Stream multiplex, for example, different programmes in the multiplex will generally also be associated with different “program ID” or “PID” values, within the more particular meaning of the MPEG2 standard, even though the PID is more closely equivalent to the viewer's concept of a “channel” (BBC1, BBC2, MTV etc.).

The invention further provides digital video recording apparatus adapted to record two or more video streams simultaneously using the aforementioned method, as further defined in the appended claims.

The recording apparatus may naturally incorporate playback apparatus for reproducing video programmes recorded according to said standard format and for reproducing a selected one of said programmes recorded simultaneously.

The invention yet further provides a record carrier wherein a two or more video streams relating to different programmes have been simultaneously recorded in the format of different viewing angles using a method according to the invention as set forth above.

### BRIEF DESCRIPTION OF THE DRAWINGS

Embodiments of the invention will now be described, by way of example only, with reference to the accompanying drawings, in which:

FIG. 1 shows a disc reading/writing apparatus according to an embodiment of the invention;

FIG. 2a shows a representation of disk space with two simultaneous streams being recorded on it at different places;

FIG. 2b shows the same representation as FIG. 2a at a later time;

FIG. 3 shows a representation of disk space on which two programmes have been recorded simultaneously on DVD using a method according to the invention;

FIG. 4 shows the arrangement of data when one programme finishes before the other; and

FIG. 5 shows the arrangement of data after one programme is overwritten by another.

### DETAILED DESCRIPTION OF THE EMBODIMENTS

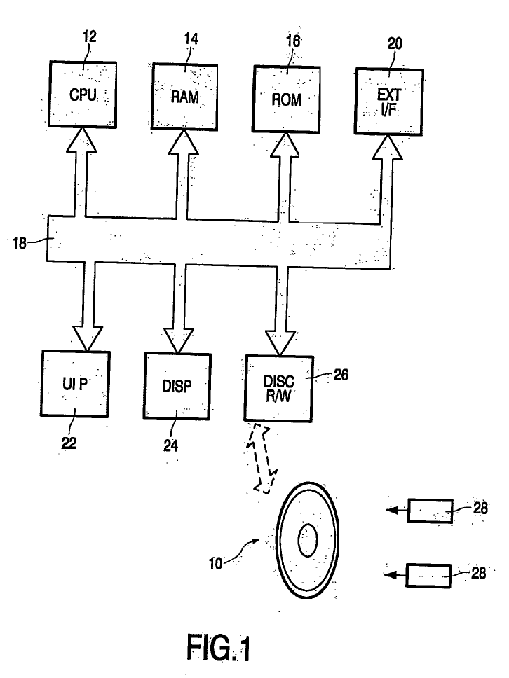

FIG. 1 shows the basic components of a data processing apparatus such as may be used for the encoding and recording of programmes to a DVD recording medium (disk) 10. The apparatus consists of a central processor (CPU) 12 coupled in a conventional manner with random-access memory (RAM) 14 and read-only memory (ROM) 16 via an address and data bus 18. An external interface (EXT I/F) 20 represents the apparatus connection with external data sources. In the case of a domestic video/audio recorder, the interface will provide the connection and reception means for the source of video and audio signals to be recorded (such as from a satellite receiver). This specific situation shows two sources 28 providing two simultaneous A/V input streams. These sources may for example be separate video tuners, internal or external to the DVD recorder. They may also be separate programmes conveyed within a single digital video broadcast multiplex, for example in MPEG2 Transport Stream format.

Also coupled with CPU 12, memories 14, 16 and interface 20 via the bus 18 are one or more user input means (UIP) 22 and a display 24. For a domestic A/V recorder apparatus they may comprise user control buttons and an LED or like display on the apparatus front panel. A further component is an interface to the storage medium, in this example an optical disk recording and playback unit (DISK R/W) 26. Unit 26 provides both the physical means to load and read and write data from and to the disk 10 and an internal set of operational protocols for reading & writing data formatted according to a predetermined standard. As will be well understood, the protocol handling of unit 26 may be effected by an internal slave processor with associated memory (not shown) with only higher-level control implemented by CPU 12, or these functions may be handled directly by CPU 12 with reference to programs held in ROM 16 and executed from there, or periodically reloaded to RAM 14. The basic construction and operation of such apparatuses are well-known to those skilled in the art and need not be described here for an understanding of the present invention.

The data on all DVD and CD disks is organized in a single spiral track. In the case of DVD Read-only media, the data is a series of pits in the media, while for recordable re-writable systems such as DVD+RW there is a single spiral groove where recorded marks are written. Actual data marks are barely visible to the human eye, but are still easily detected by a drive's optics and electronics. Each programme or section recorded on a DVD follows immediately the previous programme/section on the spiral track. No gaps are allowed between programmes for the disk to meet the requirements for playback on a standard DVD player.

The DVD Video specification and consequently the DVD+RW system does, however, allows for “multi angle” playback and recording. This allows disks to be recorded with, for example, action sequences or sport events in such a way that, during playback, the viewer is able to watch the action from a number of different views or camera angles and can pick and choose between them during playback.

To enable this “multi angle” function the DVD Video Specification provides a protocol that allows multiple video streams to be created on the disk. This is done by multiplexing small sections of each video stream, each obtained from a different camera filming the same scene/event, within one MPEG2 video stream.

When a DVD player encounters a multi-angle section of video, it simply reads the section for the angle it is displaying and then skips over the subsequent sections relating to other angles until the next section containing video for its angle is reached. In this way video from a single angle can be viewed uninterrupted. Furthermore, the angle can be changed by the viewer as desired, the player skipping to and playing the next video section for the new selected angle and all subsequent sections of this angle, again skipping all other angles.

A further feature of the multi angle playback feature of the DVD Video specification is the possibility of recording a different audio track for each camera angle. This feature, though very rarely used, allows a programme marker to improve atmosphere for a particular scene, or allow for an angle showing the “bench” or technical area in the recording of a football match wherein coaching instructions etc. can be heard.

Because the DVD Video standard was designed to be used as a medium for pre-recorded movies and programmes, it was not envisaged to record two or more programmes simultaneously (particularly as this is not possible with conventional VHS tape and therefore was possibly not regarded as an essential feature when designing DVD playback apparatus). However, such a feature is obviously desirable on a DVD Video recorder.

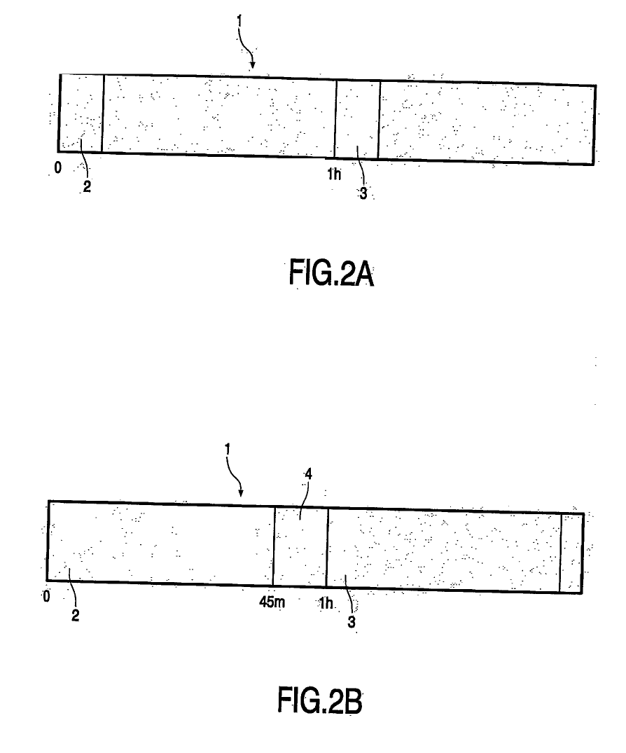

FIGS. 2a and 2b give an example why the inability to leave gaps between programmes makes it impossible to record programmes simultaneously simply by starting recording one stream at one point on the disk, and starting another stream at a different point later on the disk.

FIG. 2a shows a bar 1 representing the disk capacity of a DVD on which there is being recorded two programmes from different tuners simultaneously. The first programme is represented by the first video stream 2 and the second programme is represented by the second video stream 3. The first stream 2 is being recorded starting at the front of the disk and the recording of the second stream 3 is started at a position representing one hour into the disk.

FIG. 2b shows the situation after 45 minutes, where, at this point the first program ends. The first stream 2 ends 45 minutes into the disk and the second stream 3 is now 1 hour 45 into the disk. Therefore a blank 15-minute gap 4 is left between the end of the first stream and beginning of the second. Such a gap is not allowed if DVD compatibility is to be maintained. However, it is also impossible to start the recording of the second stream in exactly the right place as there is no way for the recorder to know the exact length of the first stream to be recorded (this is further complicated by the fact that file size is not only dependent on time).

This problem is addressed in the novel apparatus of FIG. 1 by using the multi angle feature of the DVD Video Specification to record both simultaneous A/V streams into the same MPEG2 programme stream as if they where both constituents of a multi angle section of video. This is done by multiplexing small sections of each video stream within the single MPEG2 stream.

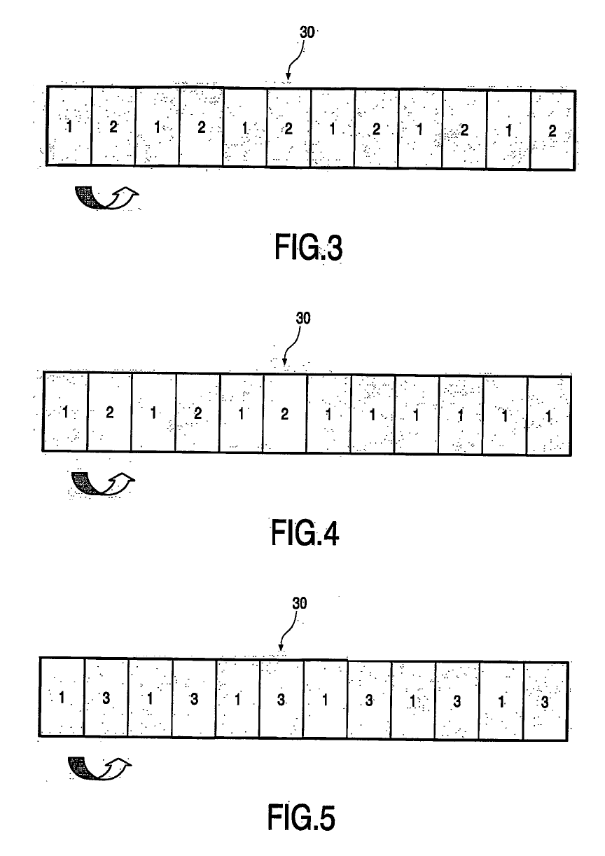

FIG. 3 shows a bar 30 representing again the disk capacity of a DVD during playback of a programme recorded simultaneously with another using the multi-angle feature. The sections marked 1 represent the first programme and 2 the second programme. When the player (not necessarily the machine which made the recording) first encounters the multiplexed section, it plays the first section it encounters containing video (and audio) for the programme selected (say the first A/V stream 1) and then skips any sections relating to other streams/programmes until it encounters the next relevant section.

The recorder arranges that (i) both programmes will appear as separate entries in the table of contents on the DVD menu, and (ii) when one of these programmes is selected for playback the player will play the same stream but from different “angles” as appropriate. To ensure that the user is kept unaware of the recording method, the “change angle” button on the remote control can be disabled during playback of any programmes recorded in this way. This is achieved by the recorder placing appropriate values in certain DVD Video structures.

This solution therefore addresses the problem of not knowing the duration of the first programme because as soon as one programme finishes, the other can be continued to be recorded, just as a normal non-multi angle stream, as illustrated in FIG. 4 (assuming that only two programmes were being recorded simultaneously). This solution also addresses the problem of too much head movement as now both or all programmes are recorded in one continuous stream. Another recording can be started at any time. Three or more programmes can be recorded simultaneously in this way if the source data is available.

If one of the programmes is subsequently to be erased, it would normally be difficult to arrange for the recorder to free the space where the erased programme is interleaved as one view within a multi-view programme. By aligning the angle sections on ECC blocks when recording the original two programmes, however, the novel recorder makes it easy for the space occupied by a recording to be re-used without requiring the other angle to be modified. FIG. 5 shows the situation after programme 2 within the recording of FIG. 3 has been erased and overwritten by programme 3.

As mentioned above, the invention is particularly applicable to the DVD standard currently in wide use, but can be applied in future systems that may replace or extend DVD. These and other variations and modifications will be readily envisaged by the skilled reader, and which can be made without departing from the spirit and scope of the invention.

1. A method of recording two or more independent video programmes simultaneously to a digital video recording medium, in a manner compliant with a standard format, the method comprising using a multi-angle feature of the standard format for multiplexing received data streams representing different programmes into one digital video data stream and recording said multiplexed video data stream to said medium.

2. A method as claimed in claim 1, wherein said standard format is DVD Video format and the multiplexed video data stream complies with MPEG2 format (CCITT H.222).

3. A method as claimed in claim 1, wherein each data stream is itself an audio-visual stream that contains multiplexed video and audio data streams.

4. A method as claimed in claim 1 further comprising recording a table of contents for said medium, in which the different angles of said multi-angle feature appear as separate entries.

5. A method as claimed in claim 1, further comprising recording control information such that, during playback of the composite digital video stream on a player compliant with said standard, the user's ability to change angle will be disabled.

6. A method as claimed in claim 1, wherein each received data stream is sourced from a different tuner.

7. A method as claimed in claim 1, wherein said received data streams are sourced as different programmes within one digital television multiplex.

8. A method as claimed in claim 7, wherein said received data streams are sourced from a multiplex complying with the MPEG2 Transport Stream format, each programme having a different programme ID within that format.

9. A method as claimed in claim 1, wherein if all but one received data stream ends during said recording, the remaining stream is recorded in standard format and without the multi-angle feature.

10. A method as claimed in claim 1 further comprising recording over one of the recorded programmes by replacing data for one angle within said multiplexed data stream, while leaving another of the recorded programmes intact.

11. A method as claimed in claim 1, wherein the multiplexed stream is recorded on the medium such that error correction code blocks on the recording medium each contain data for only one angle of the multi-angle stream.

12. A digital video recording apparatus for recording video programmes to a digital video recording medium in a manner compliant with a standard format, the apparatus comprising means for multiplexing received data streams representing at least two independent programmes into one digital video data stream using a multi-angle feature of the standard format and recording said multiplexed video data stream to said medium so as to record both programmes simultaneously.

13. Apparatus as claimed in claim 12, wherein said standard format is DVD Video format and the multiplexed video data stream complies with MPEG2 format (CCITT H.222).

14. Apparatus as claimed in claim 12, wherein each data stream is itself an audio-visual stream that contains multiplexed video and audio data streams.

15. Apparatus as claimed in claim 12 further comprising means for recording a table of contents for said medium, in which the different angles of said multi-angle feature appear as separate entries.

16. Apparatus as claimed in claim 12, further comprising means for recording control information such that, during playback of the composite digital video stream on a player compliant with said standard, the user's ability to change angle will be disabled.

17. Apparatus as claimed in claim 12, comprising means operable to receive each data stream from a different tuner.

18. Apparatus as claimed in claim 12, comprising means operable to extract data streams for the two different programmes from within one digital television multiplex.

19. Apparatus as claimed in claim 18, wherein said received data streams are sourced from a multiplex complying with the MPEG2 Transport Stream format, each programme having a different programme ID within that format.

20. Apparatus as claimed in claim 12, arranged so that wherein if all but one received data stream ends during said recording, the remaining stream is recorded in standard format and without the multi-angle feature.

21. Apparatus as claimed in claim 12 further comprising recording over one of the recorded programmes by replacing data for one angle within said multiplexed data stream, while leaving another of the recorded programmes intact.

22. Apparatus as claimed in claim 21, wherein the multiplexed stream is recorded on the medium such that error error correction code blocks on the recording medium each contain data for only one angle of the multi-angle stream.

23. (canceled)

24. (canceled)

25. (canceled)
